(19) United States
(12) Patent Application Publication
(10) Pub. No.: US 2005/0236440 A1
(43) Pub. Date: Oct. 27, 2005

(54) Cap for a container

(76) Inventor: Young Kook Cho, Huntington Park, CA (US)

Correspondence Address: Jerry H. Nob, Suite 2741, 3435 Wilshire Blvd, Los Angeles, CA, 90010, US

(21) Appl. No.: 11/114,664

(22) Filed: Apr. 25, 2005

(30) Foreign Application Priority Data
Apr. 26, 2004 (KR) 10-2004-0028847

(51) Int. Cl. B67D 5/14

(52) U.S. Cl. 222/519

(57) ABSTRACT

Disclosed herein is a cap, suitable for use in a bottle having a mouth. The cap comprises a fixing unit, which is tightened onto the mouth of the bottle. A working unit having a hollow cavity extending therethrough is rotatably fitted onto the fixing unit. An opening unit is operatively positioned with the fixing unit and working unit to move upwards and downwards in response to a predetermined rotation of the working unit, thereby opening or closing the cap.

### BACKGROUND OF THE INVENTION

1. Field of the Invention

The present invention relates to a cap for a container. More particularly, the present invention relates to a cap for a beverage bottle, which can be easily opened and closed in addition to being sanitary.

2. Description of the Related Art

Bottled water and beverages have become ever increasingly widely available everywhere. In addition, most beverages are marketed in plastic bottles. With the increase in outdoor activities, the market for sports cap bottles has been gradually growing.

Generally, most of the sports cap bottles currently sold have simple structures in which the caps are forcibly pulled out or pushed in with the fingers or the teeth. These conventional manual opening or closing manners are inferior in a sanitary aspect in addition to inconveniencing the user.

Therefore, there is a need for a sport cap structure that is not only readily opened or closed in a mechanical manner but also is sanitary for the user.

### SUMMARY OF THE INVENTION

Accordingly, the present invention has been made keeping in mind the above problems occurring in the related art and it is an object of the present invention to provide a bottle cap that can be readily opened and closed in a mechanical manner.

It is another object of the present invention to provide a bottle cap, which is superior in a sanitary aspect.

The above objects could be accomplished by the provision of a cap, suitable for use in a bottle which has a mouth, with a thread formed around the external circumferential surface thereof, comprising: a fixing unit, which is tightened onto the mouth of the bottle; a working unit, which is rotatably fitted onto the fixing unit and provided with a discharge passage; and an opening unit, which moves upward and downward in response to the rotation of the working unit, opening or closing the discharge passage, all of said units being integrally formed.

In the cap, the fixing unit comprises a plate, which extends in a radial direction to plug the mouth, with a through hole formed at a central position; an outer cap, which extends in an axial direction integrally from a circumferential end of the plate, with an internal thread formed around the internal circumferential surface thereof, the internal thread engaging with the thread of the mouth; and an inner cap, which extends in an axial direction integrally from a predetermine position spaced apart from the circumferential end of the plate, fitting into the mouth, and has an internal thread around its internal circumferential surface, with a stopper internally formed for restricting the descent of the opening unit, at a bottom position.

The working unit comprises a grip part, which is rotatably fitted onto the fixing unit; a hollow mouthpiece, which is formed at a step on the grip part and extends in an axial direction; and a core part, which is positioned at the center of the hollow mouthpiece, forming a gap therearound with respect to the internal wall side of the mouthpiece, and connected to the mouthpiece via a bridge, said gap functioning as a discharge passage through which a content of the bottle body is discharged.

The core part has a U-like shape and is provided with at least one air inlet at its side.

It is preferred that the cap further comprises an upper cap covering the mouthpiece.

While the fixing unit has a fitting ring on the plate, the working unit has a corresponding fitting groove near a circumferential edge of its bottom, whereby the working unit can be rotatably fitted with the fixing unit through the combination of the fitting ring and the fitting groove.

The opening unit integrally comprises an elevation cylinder combined with the fixing unit so as to rotate and move in an axial direction with respect to the fixing unit; and a cylindrical valve which is structured to combine with the working unit so as to move in an axial direction and to be restricted from rotating with respect to the working unit and, when ascending, is inserted outside the core part so as to close the discharge passage.

The elevation cylinder has an external thread around the external circumferential surface so as to be engaged in a screw-type fashion with the inner cap, and the cylindrical valve has at least one lengthwise locking protrusion formed on its external surface, said locking protrusion being locked with a lengthwise locking groove formed on the internal surface of the working unit.

Preferably, the elevation cylinder has at least one communication hole on the plate.

In accordance with another aspect of the present invention, the opening unit comprises a hollow cylindrical valve and a circular elevation plate, the hollow cylindrical valve being integrally formed on a central position of a circular elevation plate, with a spatial communication at the central position, the circular elevation plate being combined with the fixing unit so as to rotate and move in an axial direction with respect to the fixing unit the cylindrical valve being engaged in a screw-type fashion with the working unit so as to move in an axial direction with respect to the working unit.

In accordance with a further aspect of the present invention, the opening unit comprises an elevation cylinder and a hollow cylindrical valve which has a dome-shaped cover, the hollow cylindrical valve being integrally formed on a central position of the elevation cylinder and communicating with the elevation cylinder at the central position, the elevation cylinder being combined with the fixing unit so as to rotate and move in an axial direction with respect to the fixing unit, the cylindrical valve being combined with the working unit so as to move in an axial direction with respect to the working unit whereby the dome-shaped cover is extruded out of or hidden within the working unit.

In this cap, the dome-shaped cover has a plurality of discharge ports around the circumference and the cylindrical valve has a lengthwise air inlet grooved to a predetermined distance on its external surface, said discharge ports functioning as the discharge passage.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing the structure of a bottle cap according to a first embodiment of the present invention;

FIG. 2 is a cross sectional view showing a closed state of the bottle cap according to the first embodiment of the present invention;

FIG. 3 is a cross sectional view showing an open state of the bottle cap according to the first embodiment of the present invention;

FIG. 4 is a cross sectional view showing a closed state of a bottle cap according to a second embodiment of the present invention;

FIG. 5 is an isolated perspective view of an elevation plate of the opening unit according to the second embodiment of the present invention showing a guiding groove formed on the circumference of an elevation plate;

FIG. 6 is a cross sectional view showing an open state of the bottle cap according to the second embodiment of the present invention;

FIG. 7 is a cross sectional view showing a closed state of a bottle cap according to a third embodiment of the present invention; and

FIG. 8 is a cross sectional view showing an open state of the bottle cap according to a third embodiment of the present invention.

### DESCRIPTION OF THE PREFERRED EMBODIMENTS

Reference should now be made in detail to the preferred embodiments of the present invention, examples of which are illustrated in the accompanying drawings, wherein like reference numerals refer to like elements throughout. The embodiments are described below in order to explain the present invention by referring to the figures.

The present invention pertains to a bottle cap suitable for use in a bottle having a mouth with a thread formed around the external circumferential surface thereof.

In the present invention, the bottle cap comprises a fixing unit, which is tightened onto the mouth of the bottle, a working unit, which is rotatably fitted onto the fixing unit and provided with a discharge passage, and an opening unit, which moves upward and downward in response to the rotation of the working unit, opening or closing the discharge passage, all of the units being integrally formed.

### Embodiment 1

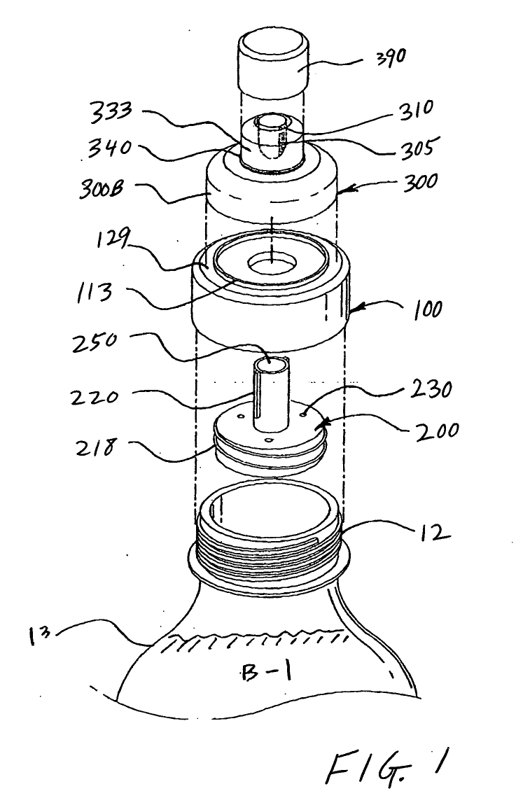

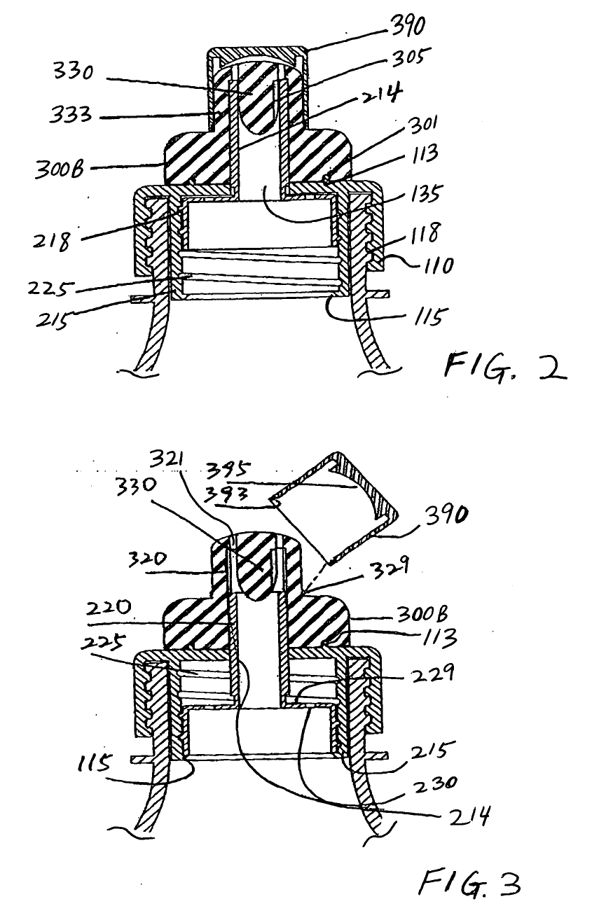

A bottle cap according to a first embodiment of the present invention is shown in an exploded perspective view in FIG. 1 for illustrating the entire structure, a cross sectional view in FIG. 2 for illustrating a combined state, and a cross sectional view in FIG. 3 for illustrating the working state of the bottle cap.

As seen in the figures, a bottle cap in accordance with the first embodiment of the present invention comprises a fixing unit 100 which is tightened onto the mouth of the bottle, a working unit 300 which is rotatably fitted onto the fixing unit and is provided with a discharge passage, and an opening unit 200 which is moved upwards and downwards by the rotation of the working unit, opening or closing the discharge passage.

The fixing unit 100 can be generally divided into a plate 129, an outer cap 110, and an inner cap 215.

Extending in a radial direction, the plate 129 generally functions to plug the mouth of the bottle. The plate 129 has a through-hole 135 in a central portion, with a fitting ring 113 formed thereon.

Integrated with the plate 129, the outer cap 110 extends in an axial direction from the circumferential terminus of the plate 129, with a thread 118 formed around the internal circumferential surface thereof. Through a screw type engagement between the thread 118 of the outer cap 110 and a thread 12 formed around the external circumferential surface of the mouth, the fixing cap unit 100 is tightened onto the mouth of a bottle body 13.

Extending in an axial direction from a predetermined internal position spaced apart from the terminus of the plate 129, the inner cap 215 is integrated with the plate 129. Likewise, the inner cap 215 has a thread formed around its internal circumferential surface. The inner cap 215 is press-inserted into the mouth of the bottle body 13 and, as described below, provides a means of lowering or raising the opening unit 200. Also, a stopper 115 internally protrudes from a lower position of the inner cap 215 to prevent the opening unit 200 from descending beyond a predetermined extent.

The opening unit 200 is generally composed of two cylindrical portions which are integrated with and concentric to each other: an elevation cylinder and a hollow cylindrical valve. While being open at the bottom, the elevation cylinder is closed at the top except for a connection with the hollow cylindrical valve 214 and for communication holes formed at regular intervals. A spiral thread 218 is provided around the external circumferential surface of the elevation cylinder. The elevation cylinder is engaged with the inner cap 215 so that the opening unit 200 moves up and down while rotating internally around the fixing unit 100.

With a smaller diameter, the hollow cylindrical valve 214 is provided on the top of the elevation cylinder. On the external circumferential side wall of the valve 214, two locking protrusions 220 are formed at opposite positions, extending lengthwise. Due to the locking protrusions 220, the hollow cylindrical valve 214 is restricted from rotating with respect to the working unit, as described below. Forming an outlet 250, the inner space of the hollow cylindrical valve 214 communicates with that of the elevation cylinder so that a content B-1 of the bottle body 13 can be transferred therethrough. Also, the elevation cylinder has communication holes 230 which are formed at regular intervals on the top.

The fixing unit 100 and the opening unit 200 are assembled by passing the hollow cylindrical valve 214 through the through-hole 135, forcibly inserting the spiral thread 218 through the stopper 115, and moving the cylindrical valve 214 upwards by the rotating the opening unit 200. That is, the thread of the inner cap 215 engages with the thread of the elevation cylinder. Thus, as the elevation cylinder moves along the screw engagement with the inner cap 215, the cylindrical valve 214 descends or ascends.

Generally, the working unit 300 comprises a grip part 300B, a mouthpiece 333 and a core part 330.

Having a circular fitting groove 301 near the circumferential edge of the bottom surface, the grip part 300B is rotatably combined with the fixing unit 100. That is, the fitting ring 113 formed on the fixing unit 100 is fitted into the fitting groove 301 so that the grip part 300B can rotate with respect to the fixing unit 100. Inside the grip part 300B, a hollow space is provided which has the same diameter as a virtual circle formed by the locking protrusions 220.

Formed at a step on the grip part 300B, the mouthpiece 333 extends in an axial direction. Like the grip part 300B, the mouthpiece 333 has a hollow space therein which is the same size as that of the grip part 300B to form a locking groove 320. Thus, a hollow space is formed, running from the bottom of the grip part 300B to the top of the mouthpiece 333.

Provided inside the hollow space of the mouthpiece 333, the core part 330 is supported via bridges 310 which are formed at upper positions of the mouthpiece 333. The core part 330 has a U-like shape, forming a gap therearound with respect to the circumferential inner wall of the mouthpiece 333. The gap functions as a discharge passage 321 through which the content B-1 of the bottle body 13 comes out of the bottle.

After moving to the upper end within the fixing unit 100, the opening unit 200 is ready to combine with the working unit 300. When the valve 214 is inserted through the through-hole 135 into the working unit 300, the locking protrusions 220 engage with the locking groove 320 formed at the inner side wall of the mouthpiece 333. At the same time as the top of the valve 214 reaches the bottom of the bridges 310 to close the bottle, the fixing unit 100 is combined with the working unit 300 by a fitting engagement between the fitting ring 113 and the fitting groove 301.

In this embodiment, an air inlet 305 may be formed in a side wall of the core part 330 from the bottom of the bridge 310 to a predetermined position in the lengthwise direction. Also, a top cap 390 may be provided for covering the mouthpiece 333.

If the grip part 300B of the working unit 300 is turned clockwise or counterclockwise, the opening unit 200 is also turned in the same direction because the locking protrusions 220 are locked with the locking groove 320. Thus, the opening unit 200 moves up or down due to the screw type engagement between the threads 218 and 225 according to the rotation direction thereof since the fixing unit 100 is fixedly tightened onto the bottle body 13.

When the opening unit 200 descends in response to the rotation of the working unit 300, the discharge passage 321 is opened so as to communicate with the inside of the bottle body 13, as shown in FIG. 3. In the case in which the air inlet 305 is provided, it is first opened upon the descent of the valve 214, in advance of the opening of the discharge passage 321. The opening unit 200 is prevented from descending by the stopper 115.

When open, the air inlet 305 aids the efflux of the content B-1 by allowing external air to pass therethrough. In addition, the communication holes 230 serve to admit gas, air, water, etc. therethrough when the opening unit moves downwards to open the bottle.

As described above, the opening unit 200 ascends by turning the working unit 300 until its top 229 closely contacts the bottom of the plate 129.

The top cap 390, which may be transparent, covers the mouthpiece 333, with a thread 393 formed around the lower internal circumferential surface. Engaging with the thread 393, a thread 329 is formed around a lower external circumferential surface of the mouthpiece 333. Through this thread engagement, the top cap 390 is tightened to the mouthpiece 333. In addition, the top cap 390 has an internal dome-shaped ceiling 395 so that a space is provided between the dome-shaped ceiling 395 and the top surface of the mouthpiece 333. In this structure, water, if contained, may be discharged through the passage 321 into the space between the top cap 390 and the mouthpiece 333 by pressing the bottle body 13. Thus, the mouthpiece can be washed with the water, which is viewed through the transparent top cap 390. The cap structure according to the present invention solves the problem in which sports bottle caps developed thus far cannot be cleaned by themselves.

### Embodiment 2

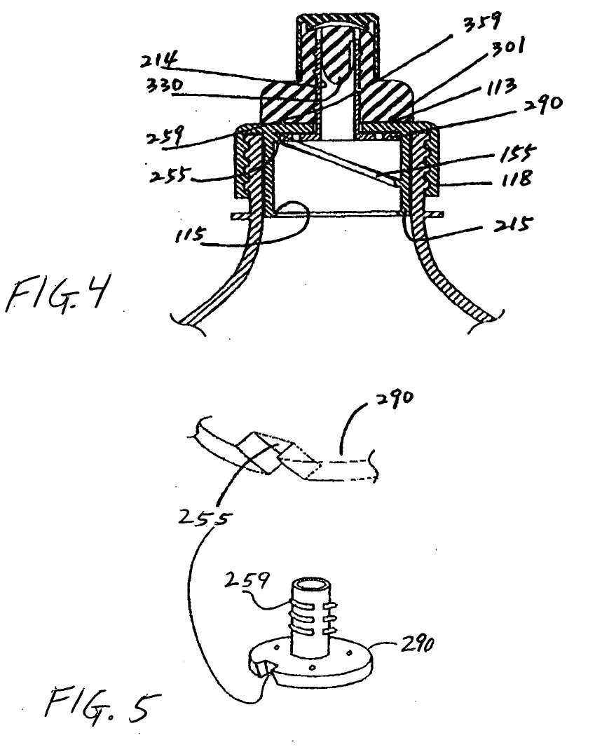

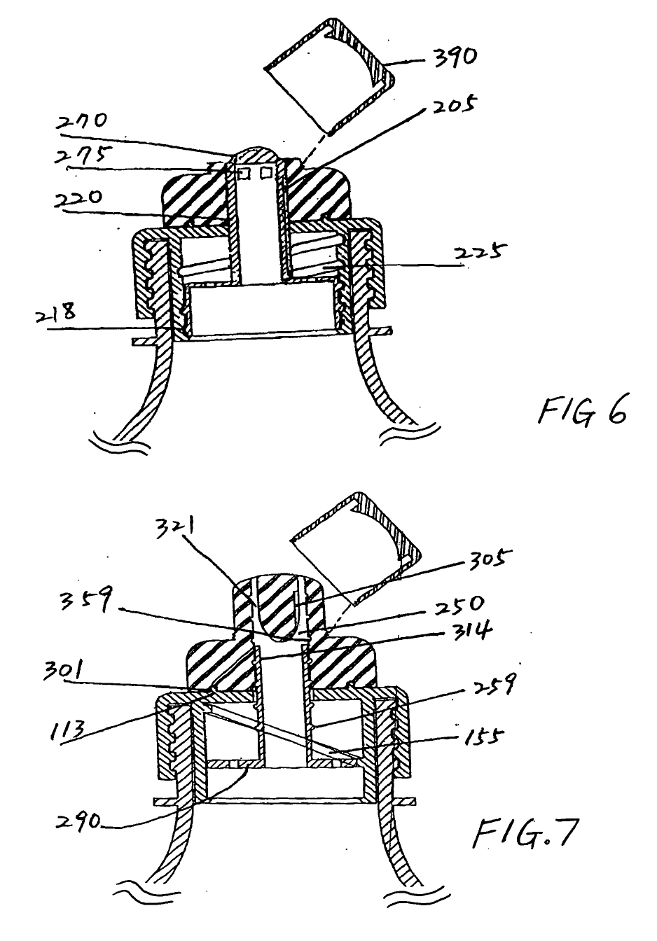

A bottle cap according to this embodiment is shown in FIGS. 4 to 6. The bottle cap according to the second embodiment of the present invention has a structure similar to that of the bottle cap according to the first embodiment, except for an opening unit 200. In the opening unit 200, a hollow cylindrical valve 214 is integrally formed on a central position of a circular elevation plate 290. At the central position, the hollow cylindrical valve 214 communicates with the circular elevation plate 290. The circular elevation plate 290 is combined with the fixing unit 100 in such a manner that the elevation plate 290 can rotate and move in an axial direction with respect to the fixing unit 100. In this regard, the elevation plate 290 has at least one guiding groove 255 on its circumferential surface, to which at least one guiding protrusion 155 formed at a gradual slope on the internal circumferential surface of the inner cap 215 is fitted.

The cylindrical valve 214 engages with the working unit 300 in a screw type fashion such that the cylindrical valve 214 can move in an axial direction with respect to the working unit 300. Upon ascending, the cylindrical valve 214 is plugged as it surrounds the core part 330 so as to close the discharge passage. The cylindrical valve 214 has an external thread 259 around its external circumferential surface, which engages with an internal thread 359 formed around the internal circumferential surface of the mouthpiece 333. As in the first embodiment, the working unit 300 can be rotated, but cannot move up and down because it is held by the fixing unit 100 with the aid of the fitting engagement between the fitting ring 113 and the fitting groove 301. Therefore, as the working unit 300 rotates, the opening unit 200 is rotated while moving up and down in response to the guiding operation. The descent of the elevation part 290 is limited by the stopper 115 protruding from a lower portion of the inner cap 215.

### Embodiment 3

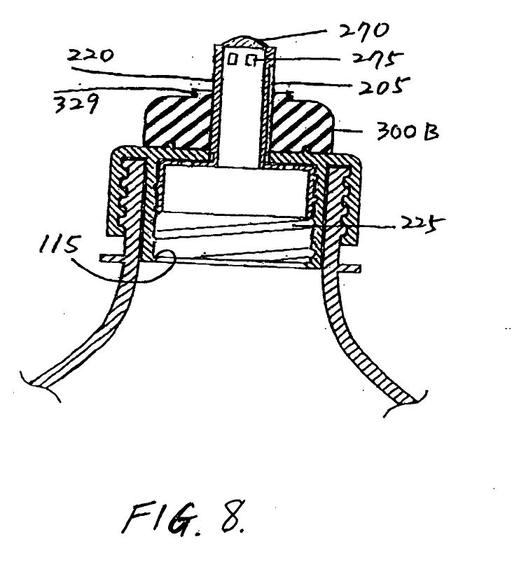

A bottle cap according to this embodiment is shown in FIGS. 7 and 8. The bottle cap according to the third embodiment of the present invention has a structure similar to that of the bottle cap according to the first embodiment. In the opening unit 200, a hollow cylindrical valve 214 is integrally formed on a central position of an elevation cylinder. At the central position, the hollow cylindrical valve 214 communicates with the elevation cylinder.

The elevation cylinder is combined with the fixing unit 100 in such a manner that the elevation cylinder can rotate and move in an axial direction with respect to the fixing unit 100. The cylindrical valve 214 is combined with the working unit 300 in such a manner that the cylindrical valve 214 can move in an axial direction with respect to the working unit 300. Unlike the first embodiment, the working unit 300 has no gap between the core part and the mouthpiece, but the valve 214 is provided with at least one port, through which the content B-1 of the bottle body 13 is discharged, at its top portion. As the elevation cylinder rotates in response to the operation of the working unit 300, the cylindrical valve 214 ascends or descends so that the port is extruded out of or embedded within the working unit 300.

In more detail, the top end of the cylindrical valve 214 has a dome-shaped cover 270 integrated therewith and is provided with a plurality of discharge ports 275 around its upper circumferential portion, in accordance with the third embodiment of the present invention. In contrast to that of the first embodiment, the working unit 300 of this embodiment has no core part, so that the gap functioning as a discharge passage is not formed between the core part and the mouthpiece. While the cylindrical valve 214 is in close contact with the internal circumferential surface of the working unit 300, the discharge ports 275 function, substituting for the discharge passage.

The opening unit 200 turns with the working unit 300 because they are locked with each other through the locking means between the locking protrusion 220 and locking groove 320. As the thread 218 of the elevation cylinder moves along the internal thread 225, the cylindrical valve 214 ascends or descends. As the valve 214 moves upwards, the discharge ports 275 are extruded out of the working unit 300. On the other hand, the discharge ports 275 are hidden within the working unit 300 when the cylindrical valve 214 descends due to the rotation of the working unit 300.

In addition, a lengthwise air inlet is grooved in the outer surface of the valve 214 in order to lessen air resistance when discharging the content.

Because the discharge ports, which are to be brought into contact with the user's lips, are hidden within the working unit, the bottle cap according to the third embodiment of the present invention looks like general sports bottle caps. Moreover, the bottle cap enjoys the advantage of being sanitary because the discharge ports can be extruded only when the content is discharged.

As described hereinbefore, the cap of the present invention can be readily opened and closed in a mechanical manner, with a sanitary advantage.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cap, suitable for use in a bottle, said cap comprising:
a fixing unit for tight connection to said bottle, said fixing unit having an aperture defined therethrough;
a working unit rotatably disposed on the fixing unit, said working unit having a discharge passage defined therethrough, said working unit having a bottom surface; and
an opening unit disposed in the working unit, said opening unit positioned to move upward and downward in response to a predetermined rotation of the working unit to open or close the discharge passage.

2. The cap as set forth in claim 1, wherein the fixing unit comprises:
a plate having said aperture defined therethrough;
an outer cap extending from around the entire edge the plate; and
an inner cap extending downward from a predetermine position spaced inward from the edge of said plate, said inner cap having a threaded inner surface, with a stopper protruding inward from a bottom position of the inner cap, said stopper formed to restrict the descent of the opening unit beyond said stopper.

3. The cap as set forth in claim 2, wherein the working unit comprises:
a grip part rotatably connected onto the fixing unit;
a mouthpiece extending upward from the grip part,
said mouthpiece and grip part defining a hollow cavity extending therethrough;
a core part positioned at a central portion of the hollow cavity near an upper portion of said mouthpiece;
one or more bridges connecting said core part to said mouthpiece; said core part sized and positioned in the hollow cavity to form a gap between said core part and mouthpiece inside said hollow cavity.

4. The cap as set forth in claim 3, wherein the core part has a U-like shape and is provided with at least one air inlet at its side.

5. The cap as set forth in claim 4, further comprising an upper cap covering the mouthpiece.

6. The cap as set forth in claim 5 further comprising:
a fitting ring protruding upward from above said plate;
a fitting groove disposed on working unit extending in a circle on the bottom surface of said working unit;
wherein said working unit can be rotatably fitted with the fixing unit through the engagement of the fitting ring with the fitting groove.

7. The cap as set forth in claim 6 wherein the opening unit comprises;
an elevation cylinder disposed within the fixing unit so as to rotate and move in an axial direction with respect to the fixing unit; and,
a cylindrical valve extending upward from the elevation cylinder, said cylindrical valve extending through said aperture of said fixing unit and into said hollow cavity of said working unit, said cylindrical valve sized to surround the core part so as to close the discharge passage with ascent of said opening unit in response to a predetermined rotation of the working unit.

8. The cap as set forth in claim 7, wherein the elevation cylinder has a theaded external circumferential surface engaged with the threaded inner surface of said inner cap, and the cylindrical valve has at least one lengthwise locking protrusion formed on its external surface, said locking protrusion being locked with a lengthwise locking groove formed on the internal surface of the working unit.

9. A cap, suitable for use in a bottle, said cap comprising:
a fixing unit for fight connection to said bottle, said fixing unit having a plate, said plate having an aperture defined therethrough;
an outer cap extending from around the entire edge the plate;
an inner cap extending downward from a predetermine position spaced inward from the edge of said plate;
a working unit rotatably disposed on the fixing unit, said working unit having a grip part and a mouthpiece extending upward from said grip part;
said working unit having a bottom surface;
said working unit defining a hollow cavity extending therethrough;
said working unit having a discharge passage in the hollow cavity near an upper portion of said mouthpiece;
an opening unit integrally disposed in the working unit, fixing unit and working unit, said opening unit having an elevation cylinder disposed within the fixing unit to move in an axial direction with respect to the fixing unit in response to a predetermined rotation of said working unit; and,
a cylindrical valve extending upward from the elevation cylinder, said cylindrical valve extending through said aperture of said fixing unit and into said hollow cavity of said working unit, said cylindrical valve sized to close the discharge passage with ascent of said opening unit in response to a predetermined rotation of the working unit.

10. The cap as set forth in claim 9 further comprising:
a stopper protruding inward from a bottom position of the inner cap, said stopper formed to restrict the descent of the opening unit beyond said stopper.

11. The cap as set forth in claim 9, wherein:
said inner cap of said fixing unit has a threaded inner surface; and
said elevation cylinder of said opening unit has a threaded outer surface in engagement with said threaded inner surface of inner cap of said fixing unit.

12. The cap as set forth in claim 11 further comprising:
a core part positioned in a central portion of the hollow cavity near an upper portion said mouthpiece;
one or more bridges connecting said core part to said mouthpiece; said core part sized and positioned in the hollow cavity to form a gap between said core part and mouthpiece inside said hollow cavity; and
wherein said cylindrical valve is sized to surround the core part so as to close the discharge passage with ascent of said opening unit in response to a predetermined rotation of the working unit.

13. The cap as set forth in claim 9 further comprising:
a fitting ring protruding upward from above said plate;
a fitting groove disposed on working unit extending in a circle on the bottom surface of said working unit;
wherein said working unit can be rotatably fitted with the fixing unit through the engagement of the fitting ring with the fitting groove.

14. The cap as set forth in claim 9, wherein:
said cylindrical valve has at least one lengthwise locking protrusion formed on its external surface,
said internal surface of the working unit has a lengthwise locking groove formed thereon for engagement with said locking protrusion to allow only an axial movement of said cylindrical valve within said working unit.

15. A cap, suitable for use in a bottle, said cap comprising:
a fixing unit for tight connection to said bottle, said fixing unit having a plate, said plate having an aperture defined therethrough;
an outer cap extending from around the entire edge the plate;
an inner cap extending downward from a predetermine position spaced inward from the edge of said plate;
a working unit rotatably disposed on the fixing unit, said working unit having a grip part and a mouthpiece extending upward from said grip part;
said working unit having a bottom surface;
said working unit defining a hollow cavity extending therethrough;
said working unit having a threaded inner surface within said hollow cavity;
said working unit having a discharge passage in the hollow cavity near an upper portion of said mouthpiece;
an opening unit integrally disposed in the working unit, fixing unit and working unit, said opening unit having an elevation plate disposed within the fixing unit to move in an axial direction with respect to the fixing unit in response to a predetermined rotation of said working unit; and,
a cylindrical valve extending upward from the elevation plate, said cylindrical valve extending through said aperture of said fixing unit and into said hollow cavity of said working unit, said cylindrical valve sized to close the discharge passage with ascent of said opening unit in response to a predetermined rotation of the working unit, said cylindrical valve having a threaded exterior surface in engagement with said threaded inner surface of said working unit.

16. The cap as set forth in claim 15 further comprising:
a stopper protruding inward from a bottom position of the inner cap, said stopper formed to restrict the descent of the opening unit beyond said stopper.

17. The cap as set forth in claim 15 further comprising:
a core part positioned in a central portion of the hollow cavity near an upper portion said mouthpiece;
one or more bridges connecting said core part to said mouthpiece; said core part sized and positioned in the hollow cavity to form a gap between said core part and mouthpiece inside said hollow cavity; and,
wherein said cylindrical valve is sized to surround the core part so as to close the discharge passage with ascent of said opening unit in response to a predetermined rotation of the working unit.

18. The cap as set forth in claim 15 further comprising:
a fitting ring protruding upward from above said plate;
a fitting groove disposed on working unit extending in a circle on the bottom surface of said working unit;
wherein said working unit is rotatably fitted with the fixing unit through the engagement of the fitting ring with the fitting groove.

19. The cap as set forth in claim 15, wherein the elevation plate has at least one guiding groove on its circumferential surface, and wherein the inner surface of the inner cap of the fixing unit has a guiding protrusion formed lengthwise in a gradual slope for engagement with said guiding groove of the elevation plate.

20. A cap, suitable for use in a bottle, said cap comprising:
a fixing unit for tight connection to said bottle, said fixing unit having a plate, said plate having an aperture defined therethrough;
an outer cap extending from around the entire edge the plate;
an inner cap extending downward from a predetermine position spaced inward from the edge of said plate;
a working unit rotatably disposed on the fixing unit, said working unit having a grip part and a mouthpiece extending upward from said grip part;
said working unit having a bottom surface;
said working unit defining a hollow cavity extending therethrough;
an opening unit integrally disposed in the working unit, fixing unit and working unit, said opening unit having an elevation cylinder disposed within the fixing unit to move in an axial direction with respect to the fixing unit in response to a predetermined rotation of said working unit; and,
a cylindrical valve extending upward from the elevation cylinder, said cylindrical valve having a top end, said cylindrical valve extending through said aperture of said fixing unit and into said hollow cavity of said working unit, said cylindrical valve having a cover for closing the top end of the cylindrical valve;
a plurality of discharge ports formed through the cylindrical valve around the circumference of the cylindrical valve below the cover of the cylindrical valve; and,
wherein the cylindrical valve engages with the working unit so as to move in an axial direction with respect to the working unit so that the cover of the cylindrical valve extrudes out of or is hidden within the working unit.

21. The cap as set forth in claim 20 further comprising:
a stopper protruding inward from a bottom position of the inner cap, said stopper formed to restrict the descent of the opening unit beyond said stopper.
